(19) United States
(12) Patent Application Publication
(10) Pub. No.: US 2009/0217146 A1
(43) Pub. Date: Aug. 27, 2009

(54) PAGE NAVIGATION GENERATION SYSTEM FOR A CUSTOMIZABLE APPLICATION

(76) Inventor: EUGENE GOLDFARB, Whitehouse Station, NJ (US)

Correspondence Address: ACCENTURE INDY 33391;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/036,120

(22) Filed: Feb. 22, 2008

(51) Int. Cl. G06F 17/00

(52) U.S. Cl. 715/205

(57) ABSTRACT

A page navigation rule generator system for a customizable application includes a page navigation rule detail module and a page navigation rule generation module. The page navigation rule detail module may be executable to receive a page navigation rule detail. The page navigation rule detail may include a page identifier to identify a display page in the customizable application, a navigation rule identifier to identify an evaluative expression, and a destination page identifier to identify a destination page in the customizable application. The page navigation rule generation module is executable to generate a page navigation rule detail entry in an application database from the page navigation rule detail. The page navigation rule detail is configurable to direct the customizable application to display a link to the destination page on the display page when the evaluative expression is determined to be a predetermined condition.

### REFERENCE TO RELATED APPLICATIONS

The following co-pending and commonly assigned U.S. patent applications have been filed on the same date as the present application: U.S. patent application Ser. No. ______, “A Conversational Question Generation System Adapted for an Insurance Claim Processing System,” (Attorney Ref. No. 10022/1099), filed herewith, U.S. patent application Ser. No. ______, “A Rule Generation System Adapted for an Insurance Claim Processing System,” (Attorney Ref. No. 10022/1159), filed herewith, and U.S. patent application Ser. No. ______, “Container Generation System for a Customizable Application”, (Attorney Ref. No. 10022/1160), filed herewith, all of which are herein incorporated by reference.

### BACKGROUND

1. Technical Field

This application relates to customizable software applications, and in particular, to a page navigation rule generation system for customizing navigation between display pages of a customizable software application.

2. Related Art

In processing insurance claims from an insurance customer, an insurance claim agent typically asks a variety of questions from the insurance customer. An insurance claim processing center may employ an insurance claim processing application for processing insurance claims from insurance customers. The insurance claim processing application may be used by various employees at the claim processing center such as insurance claim agents. The insurance claim processing application may be configured to display various graphical user interfaces, or pages, that an insurance claim agent uses when asking questions to an insurance customer and when the insurance claim agent receives answers to those questions. In some implementations, the various pages may be connected such that the question and answer session between the insurance claim agent and the insurance customer follows a logical progression based on the answers the insurance claim agent receives.

In some circumstances, the insurance claim processing center may want to modify the navigation logic that controls the logical progression of the question and answer session. For example, the insurance claim processing center may want to alter the conditions that determine when to proceed to one display page from another. In another example, the insurance claim processing center may want to modify the conditions that determine when to display hyperlinks on a display page that a claim processing agent may use to navigate between pages.

However, an insurance claim processing application is usually extremely complex. Therefore, changes to the claim processing application require the help of an individual, such as a computer program developer, who has a skill set that includes a computer programming language in which the insurance claim processing application was written. Hence, the insurance claim processing center incurs additional burdens, including fees to the computer program developer and lag time in introducing modifications. In addition, when an insurance claim processing center does not have personnel with the technical skill set to make a modification, the insurance claim processing center must incur additional time and expense in training or hiring personnel with the requisite skill set.

Moreover, making modifications to existing insurance claim processing applications may require disabling access to and shutting down the systems connected to the insurance claim processing application. This shutting down process results in downtime of the insurance claim processing center, which translates into lost revenue and lost worker productivity.

Accordingly, there is a need for a system that efficiently modifies an insurance claim processing application without requiring specialized skills.

### SUMMARY

A page navigation rule generator system for a customizable application includes a page navigation rule detail module and a page navigation rule generation module. The page navigation rule detail module may be executable to receive a page navigation rule detail. The page navigation rule detail may include a page identifier to identify a display page in the customizable application, a navigation rule identifier to identify an evaluative expression, and a destination page identifier to identify a destination page in the customizable application. The page navigation rule generation module is executable to generate a page navigation rule detail entry in an application database from the page navigation rule detail. The page navigation rule detail entry is configurable to direct the customizable application to display a hyperlink to the destination page on the display page when the evaluative expression is determined to be a predetermined condition.

The page navigation rule generator system for a customizable application may also include a user interface module. The user interface module may be executable to receive a set of page navigation rule detail entries from an application database. The application database may be configurable to customize the customizable application. Each page navigation rule detail entry of the set of page navigation rule detail entries may include a navigation rule identifier to identify an evaluative expression. The evaluative expression may be a logic expression that includes at least two operators.

The user interface module may also be executable to receive user modifications of the set of page navigation rule detail entries from a selection device, and to store the user modifications in a page navigation rule detail. The page navigation rule generation module may be executable to receive the page navigation rule detail from the user interface module, and to update the set of page navigation rule detail entries in the application database to reflect the user modifications stored in the page navigation rule detail.

Further objects and advantages of the present invention will be apparent from the following description, reference being made to the accompanying drawings wherein preferred embodiments of the present invention are clearly shown.

### BRIEF DESCRIPTION OF THE DRAWINGS

The innovation may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is an example of an insurance-related processing application implemented with a customizable application.

FIG. 2 is an example of a page navigation rule generation system.

FIG. 3 is an example of various modules included in the page navigation rule generation system of FIG. 2 in communication with the application database of FIG. 1.

FIG. 4 is an example of a screen generated with the user interface module of FIG. 3.

FIG. 5 is an example of a screen implemented by the user interface module of FIG. 3 to add a page navigation rule to a set of page navigation rules associated with a start page.

FIG. 6 is a flow diagram illustrating an example operation of a graphical user interface for configuring a customizable application to add a page navigation rule detail entry to the application database of FIG. 1.

### DETAILED DESCRIPTION

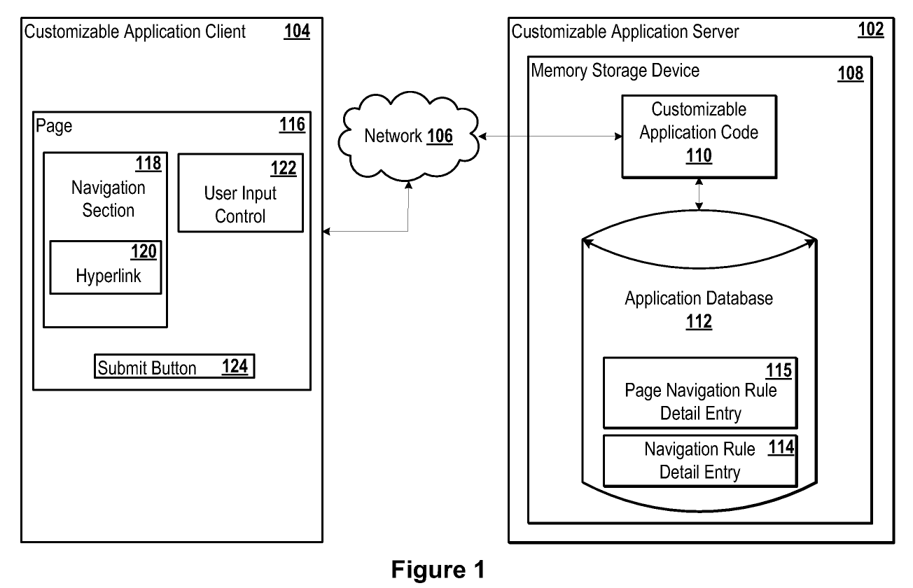

FIG. 1 is an example of an insurance-related processing application implemented with a customizable application. The customizable application is a software application designed for software program developers to modify the behavior of the insurance-related processing application. The insurance-related processing application may be, for example, an insurance claim processing application, an insurance underwriting application or any other insurance-related application used to conduct insurance-related business. It should also be recognized that the system is not limited to insurance-related applications and may instead be applied in any customizable application. The customizable application may include at least one customizable application server 102 and at least one customizable application client 104, both connected by a network 106. The customizable application server 102 may be any number of computers connectable to the network 106, and may include at least one memory storage device 108 that includes customizable application code 110 and an application database 112. The customizable application client 104 may be any number of computer or terminals connectable to the network 106 used by an insurance agent to interact with the customizable application. The application client 104 may communicate with the customizable application server 102 over the network 106 using any communication protocol, such as HTTP, HTTPS, WAP, etc. The network 106 may be any form of LAN, WAN, etc., including wireless and wire line networks.

The memory storage device 108 may be any kind of memory storage device or a combination of different kinds of memory or memory storage devices including, but not limited to, random access memory (RAM), read-only memory (ROM), hard disk, optical disk, digital video disc (DVD), compact disc read-only memory (CD-ROM), etc. The customizable application code 110 may be any computer code written in any computer language, such as Java, C++, C#, C, Visual Basic, Java Script, Perl, etc.

The application database 112 may be any electronic collection of information that is organized so that it can be accessed, managed, and updated, such as a Relational Database Management System (RDBMS), an object-oriented database, an extensible markup language (XML) database, a file system, etc. The application database 112 may be configurable to customize certain aspects of the customizable application client 104. The application database 112 may include database entries that correspond to one or more aspects of the customizable application. By configuring the database entries, aspects of the customizable application that correspond to the database entries are customized. A database entry is information that may be retrieved from the application database 112 using a unique key, such as a primary key value, a full path name, or an XML Path Language (XPATH) expression. The database entry may be stored in multiple locations in the application database 112, such as in multiple tables in an RDBMS. The customizable application code 110 may read the database entries to determine how to perform certain aspects of the customizable application.

Additionally, one or more database entries may be associated in the application database 112 with one or more other database entries. Any method of associating database entries in a database, now known or later discovered, may be used. In some examples, a first database entry is associated with a second database entry by including a unique key in the second database entry to identify the first database entry. In other examples, the first database entry is associated with the second database entry by including a unique key in the first database entry to identify the second database entry. In still other examples, an association database entry includes a unique key to identify the first database entry and a unique key to identify the second database entry. The customizable application code 110 may also read associations of database entries to determine how to perform certain aspects of the customizable application.

The customizable application may include a page 116, which may be one of many display pages or screens in the customizable application. A page or display page is a term to encompass the grouping of content between basic breaking points in the application flow displayed by applications, such as a webpage, a pop-up window, a modal or non-modal window, etc. Based on database entries stored in the application database 112, the customizable application code 110, alone or in conjunction with additional computer code executing at the customizable application client 104, may display the display pages. The page 116 may be displayed using any such application display technology, such as Hypertext Markup Language (HTML), Wireless Markup Language (WML), Visual Basic, etc.

In some examples, the page 116 may include a navigation section 118. The navigation section 118 may be any portion of the page 116, and may have any shape. The navigation section 118 may be positioned at any location on the page 116, such as at the top, bottom, left, right, middle, off center, etc. The navigation section 118 may include a hyperlink 120, which, when selected, navigates to another page of the customizable application. A hyperlink, i.e., a link, may be any user input control operable to receive a selection signal by a user, such as an <HREF> element in HTML, a button, etc. The navigation section 118 may include more than one hyperlink 120 or no hyperlink 120 at all.

In other examples, the page 116 may include a user input control 122 and a submit button 124. The user input control 122 may correspond to a question configured in the application database 112. A question may have an answer that a user of the customizable application inputs into the system. The question may be posed to the user, and the answer may be any information provided by the user in response to the question. The question may be posed to the user with, for example, the user input control 122. Likewise, the answer may be provided by the user with the user input control 122. The user input control 122 may be any type of user interface element that is used to obtain input from a user, such as a text box, a scrollable text box, a radio button group, a check box, a button, etc.

During operation of the customizable application, selection of the submit button 124 may indicate that the user has answered a question presented by the input control 122 or, in some cases, that the user wants to accept a default value in the input control 122 as the answer. The submit button 124 may be any user input control operable to receive a selection signal by a user, such as an <HREF> element in HTML, a button, etc.

The application database 112 may contain navigation rule detail entries 114 to configure rules that are Boolean expressions, where each navigation rule detail entry configures a rule. In some examples, the Boolean expressions may include one or more variables as operands. The variables may represent answers to questions. In other examples, a Boolean expression may simply be one Boolean variable. In still other examples, a Boolean expression may be a constant.

The rules may be further configured in the application database 112 to control page navigation. For example, a rule may be associated in the application database 112 with a start page 116 and a destination page through a page navigation rule detail entry 115. Any manner of making such an association in a database is possible. For example, the page navigation rule detail entry 115 may include a navigation rule identifier to identify a navigation rule detail entry 114 that configures a rule, a page identifier to identify the start page 116, and a different page identifier to identify the destination page. If, during operation of the customizable application, the rule evaluates to true and a user presses the submit button 124 on the start page 116, then the customizable application may navigate to the destination page.

In other examples, the rule may also be associated with a second destination page. Any manner of making such an association is possible. For example, the page navigation rule detail entry 115 may further include another page identifier to identify the second destination page. The custom application may navigate to the second destination page if the rule evaluates to false and to the first destination page if the rule evaluates to true.

In another example, the application database 112 may be configured to associate an ordered set of page navigation rules with the page 116 by creating an ordered set of page navigation rule detail entries 115 in the application database 112. During operation of the customizable application, if a user presses the submit button 124 on the start page 116, then the customizable application may navigate to a destination page associated with the first rule in the ordered set that evaluates to true. The customizable application may perform the navigation and evaluation logic in response to an event different than the selection of the submit button 124. For example, the customizable application may perform the navigation and evaluation logic in response to completion of entry of an answer to a question in the user input control 122.

The application database 112 may also be configurable to direct the customizable application to display a hyperlink 120 based the page navigation rules. For example, a set of page navigation rule detail entries 115 in the application database 112 may have the same page identifier that identifies the same start page 116. Each page navigation rule detail entry 115 in the set may include a navigation rule identifier to identify a navigation rule detail entry 114 that configures a rule, a page identifier to identify the start page 116, and a different page identifier to identify the destination page. Each page navigation rule detail entry 115 in the set may direct the customizable application to display a hyperlink 120 to the destination page in the navigation section 118 in response to the rule evaluating to true. The set of rules may be an ordered or unordered set. In some examples, the set of rules configured to direct display of hyperlinks 120 may be the same as the ordered set discussed earlier that controls navigation from the page 116.

The customizable application may also have a default set of hyperlinks 120 associated with the page 116, where the set of rules may direct the customizable application to add or remove hyperlinks to or from the default set of hyperlinks before displaying the hyperlinks. For example, if one of the rules associated with page 116 evaluates to false, then a hyperlink 120 that exists in the default set and links to the destination page associated with the rule may not be displayed in the navigation section 118.

In other examples, the customizable application may have a default page flow. In such examples, the default page flow may configure what page should logically follow each of the pages of the customizable application, i.e., the default next page. A destination page identifier included in a page navigation rule detail entry 115 in the application database 112 may be configured to be the default next page instead of a specific page. Changes to the default page flow configuration will not require a modification to the page navigation rule detail entry 115.

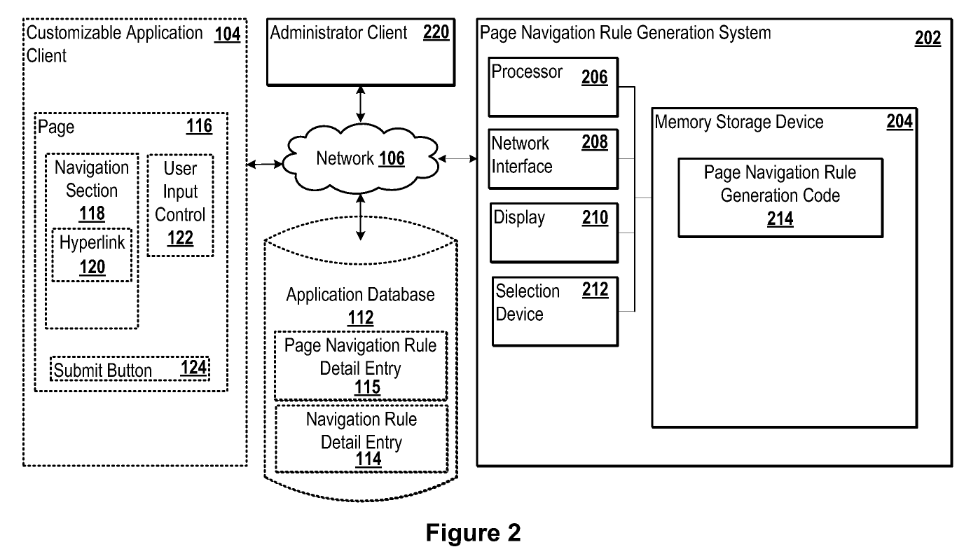

FIG. 2 is an example of a page navigation rule generation system. The page navigation rule generation system 202 may include one or more of a memory storage device 204, a processor 206, a network interface 208, a display 210 and a selection device 212. An administrator of the customizable application may customize some aspects of the customizable application by using the page navigation rule generation system 202.

The processor 206 may be any device or system capable of performing logic operations, analog or digital. The processor 206 is electrically connected to the network interface 208. The network interface 208 connects the page navigation rule generation system 202 with a network 106. The processor 206 is further electrically connected to the display 210. The display 210 is any electro-optical device for displaying data, such as a liquid crystal display (LCD), a cathode ray tube (CRT) display, an electro-luminescent display, a plasma display panel (PDP), a vacuum florescent display (VFD), etc. The selection device 212 may be any user input device such as a mouse, touchpad, microphone, keyboard, or any other mechanisms and/or systems that provide a communication path to exchange data between users and systems.

The memory storage device 204 may be any kind of memory storage device or a combination of different kinds of memory or memory storage devices including, but not limited to, random access memory (RAM), read-only memory (ROM), hard disk, optical disk, digital video disc (DVD), compact disc read-only memory (CD-ROM), etc. The memory storage device 204 is in communication with the processor 206. The memory storage device 204 may contain page navigation rule generation code 214 which is computer code written in any computer language, such as Java, C++, C#, C, Visual Basic, Java Script, Perl, etc. The page navigation rule generation code 214 is executable with the processor 206.

In reference to FIGS. 1 and 2, the page navigation rule generation code 214 may access the application database 112 during operation of the page navigation rule generation system 202. In some examples, the application database 112 may be accessible on the network 106. In other examples, the memory storage device 204 may include the application database 112. The application database 112 is configurable to customize the customizable application. The administrator, interacting with the page navigation rule generation system 202 through the selection device 212 and the display 210, may direct the page navigation rule generation code 214 to modify database entries in the application database 112 to customize the customizable application. During operation of the customizable application, an insurance claim agent may view the customized page 116 at the customizable application client 104. Thus, the administrator may customize the customizable application used by the insurance claim agent.

In some examples, the customizable application server 102 and the page navigation rule generation system 202 may be the same computer. In other examples, the customizable application server 102 and the page navigation rule generation system 202 may be different computers.

The page navigation rule generation system 202 may be any number of computers connectable to the network 106. An administrator client 220 may be any number of computer or terminals connectable to the network 106. The administrator client 220 may communicate with the page navigation rule generation system 202 over the network 106 using any communication protocol, such as HTTP, HTTPS, WAP, TCP/IP, etc. The network 106 may be any form of LAN, WAN, etc., including wireless and wire line networks. The administrator may use the administrator client 220 or the page navigation rule generation system 202. In other examples, any user may use the administrator client 220 or the page navigation rule generation system 202. In still other examples, users belonging to other security groups may use the administrator client 220 or the page navigation rule generation system 202.

In some examples, the page navigation rule generation system 202 may not include the display 210 and the selection device 212. Instead, the administrator client 220 may include the display 210 and the selection device 212. During operation, the administrator may interact with the page navigation rule generation system 202 through the selection device 212 and the display 210 at the administrator client 220.

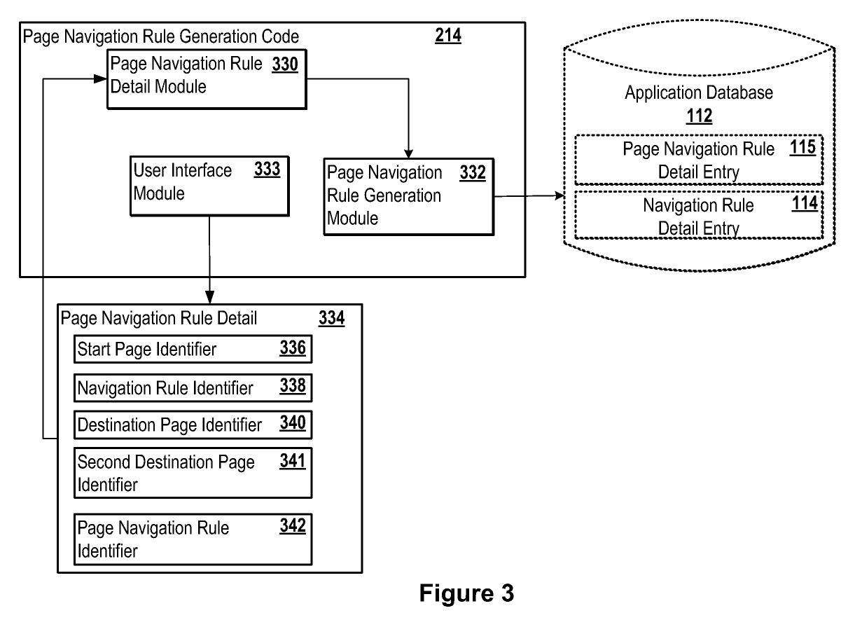

FIG. 3 is an example of various modules included in the page navigation rule generation code 214 of FIG. 2 in communication with the application database 112 of FIG. 1. Page navigation rule generation code 214 may include a page navigation rule detail module 330, a user interface module 333 and a page navigation rule generation module 332. The modules described are but one example of the functionality described. In other examples, the described functionality may be described in fewer or greater numbers of modules. The page navigation rule detail module 330, the navigation rule generation module 332, and the user interface module 333 include computer code.

In addition to the page navigation rule generation code 214, the memory storage device 204 of FIG. 2 may also contain a page navigation rule detail 334. The user interface module 333 is executable to communicate with a user of the page navigation rule generation system 202 to create the page navigation rule detail 334. The page navigation rule detail module 330 is executable to receive the page navigation rule detail 334 from the user interface module 333 or some other source as discussed below.

The page navigation rule detail 334 may contain parameters. Based on the parameters of the page navigation rule detail 334 received by the page navigation rule detail module 330, the page navigation rule generation module 332 is executable to create or modify database entries in the application database 112 to configure the customizable application. For example, the page navigation rule generation module 332 may create or modify the page navigation rule detail entry 115 or the navigation rule detail entry 114 in the application database 112. Therefore, the page navigation rule detail 334 may contain any parameter or combination of parameters necessary to create or modify one or more database entries.

For example, the page navigation rule detail 334 may include a start page identifier 336 to identify the start page 116, a navigation rule identifier 338 to identify a rule configured by the navigation rule detail entry 114, and a destination page identifier 340 to identify a destination page. With such a page navigation rule detail 334, the page navigation rule generation module 332 may create a page navigation rule detail entry 115 in the application database 112. In another example, page navigation rule detail 334 may also include a page navigation rule identifier 342 to identify a page navigation rule detail entry 115 that already exists in the application database 112. With such a page navigation rule detail 334, the page navigation rule generation module 332 may modify the page navigation rule detail entry 115.

In some examples, the page navigation rule detail 334 may include both a first destination page identifier 340 and a second destination page identifier 341. In such examples, the page navigation rule detail entry 115 may include a first unique key to identify a first destination page that corresponds to the rule evaluating to a first predetermined value such as true, and a second unique key to identify a second destination page that corresponds to the rule evaluating to a second predetermined value different than the first predetermined value such as false. If the rule evaluates to more than two possible values, the page navigation rule detail 334 may include more than two destination page identifiers, 340 and 341, each corresponding to a different possible value.

In other examples, the page navigation rule detail module 330 is executable to receive a set of page navigation rule details 334. Accordingly, the page navigation rule generation module 332 may create or modify a set of page navigation rule detail entries 115 in the application database 112. If the set of page navigation rule details 334 is an ordered set, each page navigation rule detail 334 may contain a position identifier to identify a position in the ordered set. In an ordered set, each member of the ordered set has a sequential relationship to the other members, permitting iteration through the members of the ordered set. In any iteration through the members, the members will appear in the same order. In still other examples, the memory storage device 204 may contain a set object that includes a set of page navigation rule details 334, where the set object includes the position identifier instead of each of the page navigation rule details 334. These examples are merely illustrative and should not be construed to limit the method of passing sets of parameters among code modules.

In some examples, the page navigation rule detail 334 may include a logic expression, such as a Boolean expression that represents the rule. The page navigation rule generation module 332 may create or modify a page navigation rule detail entry 115. In other examples, the page navigation rule detail 334 may include one or more other evaluative expressions that represent the rule and evaluate to one of more than two predetermined values. The page navigation rule detail 334 may also include a navigation rule identifier 338 to identify the rule configured by the navigation rule detail entry 114. All of the examples given above are merely illustrative and are not meant to be construed to limit the parameters that may be included in the page navigation rule detail 334.

The page navigation rule detail module 330 is executable to receive the page navigation rule detail 334 from any data source. For example, as previously discussed, the page navigation rule detail module 330 may receive the navigation rule generation code detail 334 from the user interface module 333. In another example, the page navigation rule detail module 330 may receive the page navigation rule detail 334 from computer code executable to retrieve data stored in a file. In still another example, the page navigation rule detail module 330 may receive the page navigation rule detail 334 from over a network using a protocol such as Simple Object Access Protocol (SOAP).

The page navigation rule detail module 330 may additionally execute computer code in a security layer to perform a security check of the current user for security authorization. Such a check may be done to ensure that the current user executing the navigation rule detail module 330 has the privileges necessary to customize the customizable application through configuring the application database 112. In one example, the current user executing the page navigation rule detail module 330 may be required to be a member of a security group such as an administrator group.

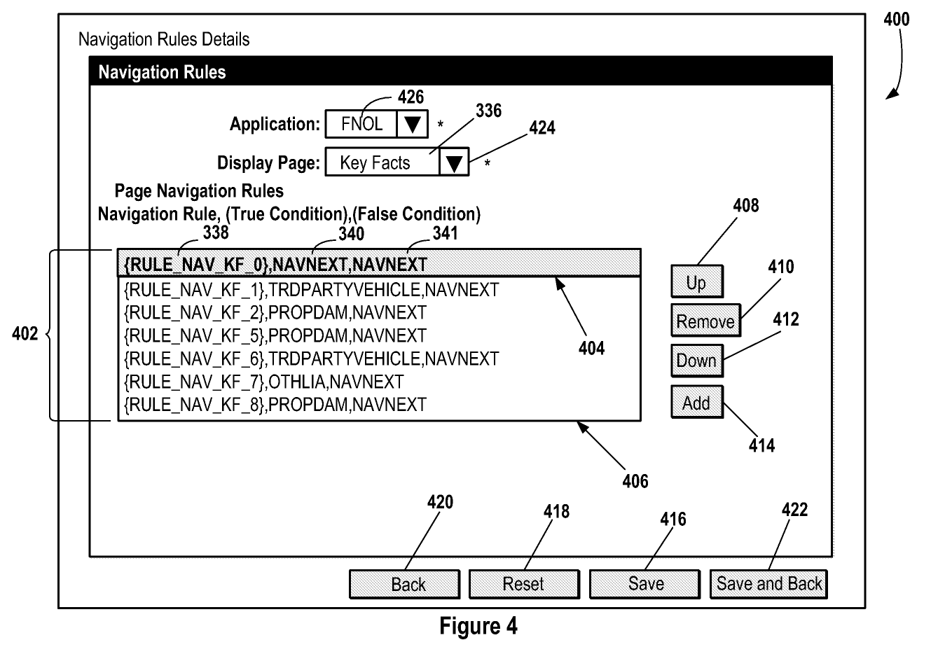

FIG. 4 is an example of a screen generated with the user interface module 333 of FIG. 3. Parameters of a page navigation rule detail 334 (FIG. 3) may be displayed in a window 400 on the screen. The screen may be generated on the administrator client 220 or the display 210 of FIG. 2. In this example, a start page identifier 336 is displayed in the window 400. A set 402 of page navigation rules 404 are also displayed in a text box 406 in the window 400. A navigation rule identifier 338, a first destination page identifier 340 and a second destination page identifier 341 of each of the page navigation rules 404 are also displayed. The navigation rule identifier 338 identifies a rule. The first destination page identifier 340 identifies a first destination page that the customizable application may navigate to when the navigation rule 338 evaluates to true. The second destination page identifier 341 identifies a second destination page that the customizable application may navigate to when the navigation rule 338 evaluates to false. In other examples, another format or configuration of a screen including similar functionality may be generated. Also in other examples, any other form of logic may be evaluated to navigate to any number of other pages or locations.

In this example, the window 400 includes four buttons: an up button 408, a down button 412, a remove button 410, and an add button 414. Each of the four buttons may be any user input control operable to receive a selection signal by a user, such as an <HREF> element in HTML, a button, etc. In other examples, fewer or greater buttons may be displayed, any combination of the four buttons may be displayed, or none of the four buttons may be displayed.

Referring to FIGS. 3 and 4, during operation, the user interface module 333 may modify the set 402 of the page navigation rules 404 based on receipt of the selection signal from the up button 408, the down button 412, the remove button 410, and the add button 414. The user may select a page navigation rule 404 with a selection device. The user interface module 333 may then move the order in the set 402 of the selected page navigation rule 404 up in response to receiving a selection signal from the up button 408. Conversely, the user interface module 333 may move the order of the selected page navigation rule 404 down in the set 402 in response to receiving a selection signal from the down button 412. The user interface module 333 may remove the selected page navigation rule 404 from the set 402 in response to receiving a selection signal from the remove button 410.

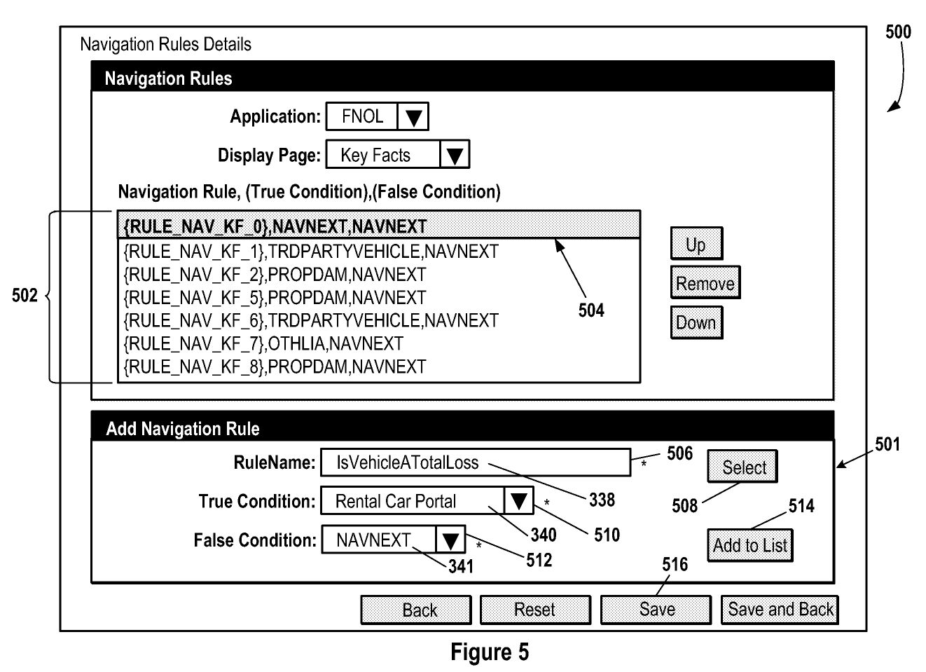

The user interface module 333 may add a new page navigation rule 404 to the set 402 in response to receiving a selection signal from the add button 414. A page navigation rule 404 may not need to be selected first. However, in some examples, if a page navigation rule 404 is first selected, the new page navigation rule 404 may be inserted before or after the selected page navigation rule 404. One example of a screen to add new page navigation rule 404 is shown in FIG. 5 and described later.

In other examples, any other mechanism may be used to select, change, order, remove or add page navigation rules 404, such as, selecting with keyboard shortcuts in conjunction with pressing a particular key, selecting with a mouse and then making a menu selection, etc. Any other mechanism for displaying lists of items may be used to display the set 402 of page navigation rules 404. For example, a grid control may be used, displaying the navigation rule identifier 338, the first destination page identifier 340 and the second destination page identifier 341 of each of the page navigation rules 404 in three columns of the grid control. In still other examples, the window 400 may be used to display one page navigation rule 404 at a time.

In this example, the window 400 also includes four additional buttons: a save button 416, a reset button 418, a back button 420, and a save plus back button 422. Each of the four additional buttons may be any user input control operable to receive a selection signal by a user, such as an <HREF> element in HTML, a button, etc. In other examples, any combination of the four additional buttons may be displayed or none of the four buttons may be displayed.

Referring to FIGS. 3 and 4, during operation, in response to receiving a save command, such as a user selecting the save button 416, the user interface module 333 may create a page navigation rule detail 334 with parameters that reflect the modifications made by the user in the window 400. The page navigation rule detail module 330 may receive the page navigation rule detail 334, and the page navigation rule generation module 332 may modify the application database 112 based on the parameters in the page navigation rule detail 334.

In response to the user selecting the reset button 418, the user interface module 333 may roll back any changes made using the window 400 since last saved, and redisplay the window 400 with the set 402 of page navigation rules 404 as of the last save. In response to the user selecting the back button 420, the user interface module 333 may navigate to a prior window from which the user navigated to the window 400. In response to the user selecting the save and back button 422, the user interface module 333 may perform the same actions as if the user selected the save button 416 and then selected the back button 420. In other examples, any other mechanism may be used to send a select signal indicative of a user desiring a rollback or a return to the prior window. For example, selecting with keyboard shortcuts in conjunction with pressing a particular key, selecting with a mouse and then making a menu selection, etc.

In this example, the start page identifier 336 is displayed in a list box 424 with which a user may select the start page identifier 336. However, any method of selecting from a list may be used. For example, another method would be for the user interface module 333 to display another screen or dialog box window from which the user may perform a search of pages. In some examples, the start page identifier 336 may be unselected when the user interface module 333 first displays the window 400.

The list of start page identifiers from which to select may be from all pages in the customizable application or some subset thereof. Furthermore, the list of start page identifiers may be restricted by an application identifier. If the customizable application supports multiple applications from the application database 112, then the user interface module 333 may display an application identifier 426 on the window 400. In one example, the customizable application may support a first notice of loss application (FNOL) and an underwriting application. In other examples any combination of insurance-related applications or other customizable applications may be supported. Any method for selecting an item from a list may be used to select the application identifier 426.

In alternative examples, the start page identifier 424 may be selected in a different window and merely displayed in this window 400. Similarly, the application identifier may be selected in a different window and merely displayed in this window 400.

In still other examples, the list of start page identifiers or the application identifier 426, or both, may be determined by the security groups to which a user belongs, or by security privileges that the user has. Access to the screens generated by the user interface module 333, such as the screens illustrated in FIGS. 4 and 5, may be limited by the security groups to which the user belongs or by the security privileges that the user has.

The set 402 of page navigation rules 404 may configure the application database 112 to control the display of hyperlinks or page navigation as described with reference to FIG. 1. Accordingly, the set 402 may be an ordered set or an unordered set.

FIG. 5 is an example of a screen implemented by the user interface module of FIG. 3 to add a page navigation rule to a set of page navigation rules associated with a start page. A window 500 of the screen may be similar in appearance and behavior to the screen shown in FIG. 4. The example window 500 is different primarily because the window 500 includes a new page navigation rule section 501 that permits the user to enter a new page navigation rule 504 to a set 502 of page navigation rules 504. In other examples, the new page navigation rule section 501 may be displayed in a new window different from the rest of the window 500.

In this example, a navigation rule identifier 338, a first destination page identifier 340 and a second destination page identifier 341 of each of the page navigation rules 404 are displayed in the new page navigation rule section 501. The navigation rule identifier 338 identifies the navigation rule, the first destination page identifier 340 identifies a first destination page to navigate to when the navigation rule evaluates to true, and the second destination page identifier 341 identifies the second destination page to navigate to when the navigation rule evaluates to false. More destination pages could be displayed that correspond to additional possible values if the navigation rule could evaluate to more values than just true or false. In other examples, where the application database 112 of FIG. 3 is configurable to use only one destination page, only one destination page identifier 340 may be displayed.

Any method of displaying text may be used to display the navigation rule identifier 338, and any method of selecting an item from a list may be used to select the navigation rule identifier 338. In this example, the navigation rule identifier 338 is displayed in a text box 506. During operation of the window 500, the user may select the navigation rule identifier 338 by selecting a select button 508 with a selection device. Upon receipt of a selection signal from the select button 508, the user interface module 333 may display a new screen to permit the user to search for a desired navigation rule. In other examples, the navigation rule identifier 338 may be displayed in plain text and manually entered, or the navigation rule identifier 338 may be displayed and selected using a list box.

Any method of displaying text may be used to display the first destination page identifier 340, and any method of selecting an item from a list may be used to select the first destination page identifier 340. In this example, the first destination page identifier 340 is displayed in a list box 510 with which a user may select the first destination page identifier 340. In other examples, the user interface module 333 may display another screen or dialog box window from which the user may perform a search of pages. In some examples, the first destination page identifier 340 may be unselected when the user interface module 333 first displays the new page navigation rule section 501.

Similarly, any method of displaying text may be used to display the second destination page identifier 341, and any method of selecting an item from a list may be used to select the second destination page identifier 341. In this example, the first destination page identifier 341 is displayed in a list box 512 with which a user may select the second destination page identifier 341. In other examples, the user interface module 333 may display another screen or dialog box window from which the user may perform a search of pages. In some examples, the second destination page identifier 341 may be unselected when the user interface module 333 first displays the new page navigation rule section 501.

The new page navigation rule section 501 may include an add button 514. The add button 514 may be any user input control operable to receive a selection signal by a user, such as an <HREF> element in HTML, a button, etc. During operation of the window 500, when a user selects the add button 514, the user interface module 333 may add a page navigation rule 504 to the set 502 of page navigation rules 504. The added page navigation rule 504 may include a rule identified by the navigation rule identifier 506, a first start page identified by the first start page identifier 340, and a second start page identified by the second start page identifier 341.

Similar to the example shown in FIG. 4, the window 500 may also include a save button 516. The save button 516 may be any user input control operable to receive a selection signal by a user, such as an <HREF> element in HTML, a button, etc. If the user selects the save button 516, the set 502 of page navigation rules 504 that includes the page navigation rule 504 selected in the new page navigation rule section 501 may be added or modified in the application database 112 (FIG. 3). In other examples, the page navigation rule 504 selected in the new page navigation rule section 501 may be added or modified in the application database 112 when the user selects the add button 514.

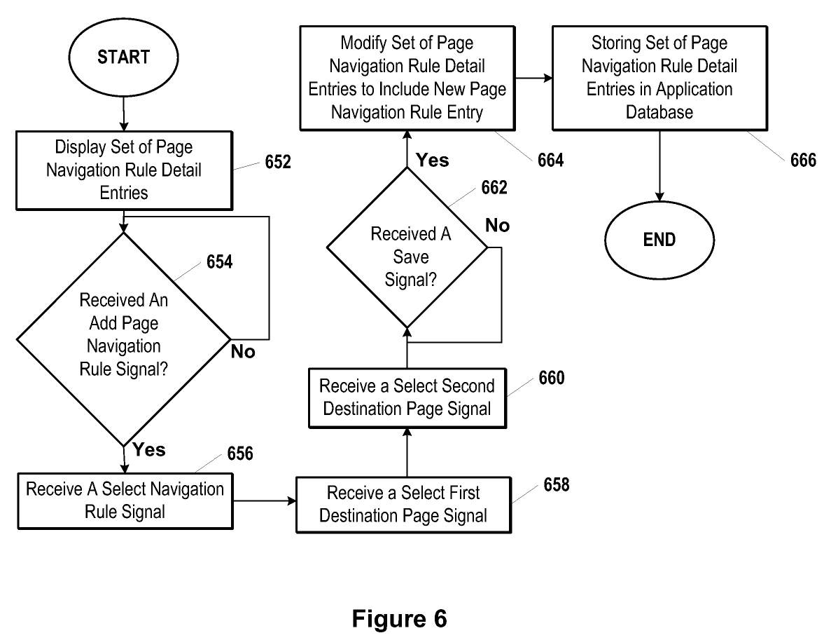

FIG. 6 is a flow diagram illustrating an example operation of a graphical user interface for configuring a customizable application to add a page navigation rule detail entry to the application database of FIG. 1. The graphical user interface may include a display and a selection device. As discussed previously, a user interface module 333 (FIG. 3) may implement display of the graphical user interface.

The operation begins at block 652 by displaying a set of page navigation rule detail entries 115 in the display that are associated in an application database 112 with a start page 116 (FIG. 1). In some examples, displaying the set of page navigation rule detail entries 115 includes displaying a subset of the associated navigation rule detail entries 115.

The operation may continue to block 654, and check to see if the user interface module 333 has received an add page navigation rule signal from the selection device. If not, the operation may return to block 654 to continue checking for the receipt of an add page navigation rule signal.

Alternatively, if the user interface module 333 has received an add page navigation rule signal, the operation may continue to block 656. The operation, at block 656, receives a select navigation rule signal indicative of the selection device selecting a navigation rule identifier 338 (FIG. 3) that identifies a navigation rule configured in the application database 112.

At block 658, the operation may continue by receiving a select first destination page signal indicative of the selection device selecting a first destination page identifier 340. The first destination page identifier 340 identifies a page that corresponds to the navigation rule evaluating to a first condition.

At block 660, the operation may continue by receiving a select second destination page signal indicative of the selection device selecting a second destination page identifier. The second destination page identifier identifies a page that corresponds to the navigation rule evaluating to a second condition.

At block 662, the operating continues by checking whether the user interface module 333 has received a save signal from the selection device. If not, the operation may return to block 662 to continue checking for the receipt of a save signal.

Alternatively, if the user interface module 333 has received a save signal, the operation may continue to block 664. At block 664, the operation continues by modifying the set of page navigation rule detail entries 115 to include a new page navigation rule detail entry 116. The new page navigation rule detail entry 116 may include the navigation rule identifier, the first destination page identifier, and the second destination page identifier.

The operation concludes at block 666, by storing the modified set of page navigation rule detail entries 116 in the application database 112. Storing the modified set of page navigation rule detail entries 116 may include modifying a set already stored in the application database 112, or creating a new set in the application database 112.

All of the previous discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other machine-readable media, for example, secondary storage devices such as hard disks, floppy disks, and CD-ROMs; a signal received from a network; or other forms of ROM or RAM either currently known or later developed. Moreover, the various modules and screen display functionality is but one example of such functionality, and any other configurations encompassing similar functionality are possible.

Furthermore, although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. Programs may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A page navigation rule generation system for a customizable application, the page navigation rule system comprising:
a processor and a memory storage device, the memory storage device including computer code executable with the processor, the computer code comprising:
a page navigation rule detail module executable to receive a page navigation rule detail, the page navigation rule detail comprising a page identifier to identify a display page in the customizable application, a navigation rule identifier to identify a logic expression, and a destination page identifier to identify a destination page in the customizable application; and
a page navigation rule generation module executable to generate a page navigation rule detail entry in an application database from the page navigation rule detail, wherein the page navigation rule detail entry is configurable to direct the customizable application to display a link to the destination page on the display page in response to a predetermined value of the logic expression.

2. The page navigation rule generation system of claim 1, wherein the destination page identifier is a first destination page identifier, the destination page is a first destination page, and the link is a first link, wherein the page navigation rule detail further comprises a second destination page identifier to identify a second destination page, and the page navigation rule detail entry is further configurable to direct the customizable application to display a second link to the second destination page in response to a second predetermined value of the logic expression different from the first predetermined value.

3. The page navigation rule generation system of claim 1, wherein the navigation rule identifier is represented as the logic expression.

4. The page navigation rule generation system of claim 1, wherein the page navigation rule detail module is executable to receive a plurality of page navigation rule details, and the page navigation rule generation module is executable to generate a plurality of page navigation rule detail entries in the application database from the page navigation rule details.

5. The page navigation rule generation system of claim 4, wherein the customizable application is configurable to display a plurality of default links in the display page, the default links comprise a default link, the default link includes a linked page, and wherein the navigation rule detail entry is configurable to direct the customizable application to display the default link unless the linked page is the destination page and the logic expression is determined to be a predetermined value.

6. The page navigation rule generation system of claim 1, wherein the customizable application is configured with a default page flow, the destination page identifier is a next page identifier, and the next page identifier represents a next page in the default page flow from the display page.

7. The page navigation rule generation system of claim 1, wherein the page navigation rule detail module is executable to receive the page navigation rule detail from a network using a Simple Object Access Protocol.

8. The page navigation rule generation system of claim 1, wherein the computer code further comprises a user interface module, the user interface module is executable to receive user input from a selection device to create the page navigation rule detail, and the page navigation rule detail module is executable to receive the page navigation rule detail from the user interface module.

9. The page navigation rule generation system of claim 1, wherein the page navigation rule generation module is executable to generate the page navigation rule detail entry based on security authorization of a user.

10. A page navigation rule generation system comprising:
a processor;
a memory storage device in communication with the processor, the memory storage device including computer code, the computer code executable with the processor and comprising:
a user interface module executable to receive a set of page navigation rule detail entries from an application database, the application database configurable to customize a customizable application, wherein:
each of the page navigation rule detail entries is configurable to customize navigation behavior of a display page of the customizable application;
each of the page navigation rule detail entries includes a navigation rule identifier to identify a logic expression, the logic expression comprising at least two operators;
each of the page navigation rule detail entries includes a destination page identifier to identify a destination page in the customizable application;
each of the page navigation rule detail entries is configurable to direct the customizable application to navigate from the display page to the destination page of each of the page navigation rule detail entries in response to the logic expression identified by a respective one of the page navigation rule detail entries being determined to be a predetermined value;
the user interface module is executable to receive user modifications of the set of page navigation rule detail entries and to store the user modifications in a page navigation rule detail; and
the user interface module is executable to receive a save command from a user; and
a page navigation rule generation module executable to receive the page navigation rule detail from the user interface module upon receipt of the save command, and to modify the set of page navigation rule detail entries in the application database to reflect the user modifications stored in the page navigation rule detail.

11. The page navigation rule generation system of claim 10, wherein the set of page navigation rule detail entries received from the application database is an empty set.

12. The page navigation rule generation system of claim 10, wherein the set of page navigation rule detail entries updated in the application database is an empty set.

13. The page navigation rule generation system of claim 10, wherein the user interface module is executable to receive from a selection device a page identifier to identify the display page.

14. The page navigation rule generation system of claim 10, wherein the user modifications include an addition of a new page navigation rule detail entry.

15. The page navigation rule generation system of claim 10, wherein the user modifications include a new logic expression identified by the respective one of the page navigation rule detail entries.

16. The page navigation rule generation system of claim 15, wherein the new logic expression is represented as text.

17. The page navigation rule generation system of claim 10, wherein the destination page identifier is a first destination page identifier, the destination page is a first destination page, the predetermined value is a first predetermined value, each of the page navigation rule detail entries further includes a second destination page identifier to identify a second destination page in the customizable application, and each of the page navigation rule detail entries is also configurable to direct the customizable application to navigate from the display page to the second destination page of each of the page navigation rule detail entries in response to the logic expression identified by the navigation rule of each of the page navigation rule detail entries determined to be a second predetermined value different than the first predetermined value.

18. The page navigation rule generation system of claim 10, wherein the user interface module is executable to receive an application identifier to identify one of a plurality of applications implemented with the customizable application and configured with the application database.

19. The page navigation rule generation system of claim 10, wherein the logic expression includes an operand, the operand is a variable, and the variable represents a user-provided answer to a question, the question is displayed in one of a plurality of display pages of the customizable application, and the user-provided answer is entered in the one of the display pages.

20. In a computer system comprising a graphical user interface including a display and a selection device, a method of configuring page navigation of a customizable application, the method comprising:
displaying on the display at least one page navigation rule detail entry of a set of page navigation rule detail entries, wherein:
each of the page navigation detail rule entries is configurable to customize navigation behavior of a display page of the customizable application;
each of the page navigation rule detail entries includes a navigation rule identifier to identify a navigation rule, the navigation rule comprising an evaluative expression;
each of the page navigation rule detail entries includes a destination page identifier to identify a destination page of the customizable application; and
each of the page navigation rule detail entries is configurable to direct the customizable application to navigate from the display page to the destination page of each of the page navigation rule detail entries in response to the navigation rule evaluating to a predetermined condition;
receiving modification signals from the selection device, the modification signals indicative of the selection device selecting a new navigation rule identifier from a plurality of navigation rules defined in the application database, and the modification signals indicative of the selection device selecting a new destination page identifier to identify a new destination page of the customizable application; and
modifying the set of page navigation rule detail entries in the application database in response to receipt of the modification signals, wherein modifying the set of the page navigation rule detail entries includes adding a new page navigation rule detail entry to the set, the new page navigation rule detail entry comprising the new navigation rule identifier and the new destination page identifier.
